(19) United States
(12) Patent Application Publication
(10) Pub. No.: US 2025/0370546 A1
(43) Pub. Date: Dec. 4, 2025

(54) FULL DISPLAY REARVIEW ASSEMBLY VIDEO MANAGEMENT SYSTEM

(71) Applicant: Gentex Corporation, Zeeland, MI (US)

(72) Inventors: Leah R. Hoffmeyer, Coloma, MI (US); Eric S. Sloterbeek, Hudsonville, MI (US); Michael J. Taylor, Dorr, MI (US); Bradley R. Hamlin, Allendale, MI (US)

(21) Appl. No.: 19/220,518

(22) Filed: May 28, 2025

Related U.S. Application Data
(60) Provisional application No. 63/652,248, filed on May 28, 2024.

(51) Int. Cl. G06F 3/01; B60R 1/26; E05F 15/73; G06T 3/40; H04N 23/90

(52) U.S. Cl. CPC G06F 3/017; B60R 1/26; E05F 15/73; G06T 3/40; H04N 23/90; B60R 2300/306; B60R 2300/8006; B60R 2300/8046; E05F 2015/767; E05Y 2900/542

(57) ABSTRACT

A display system for a vehicle is disclosed. The display system includes a display device disposed in a passenger compartment of the vehicle, the display device comprising a screen; at least one sensor for sensing a user's hand gestures; and a controller in communication with the display device, the at least one sensor, and a plurality of imagers configured to capture image data in a plurality of different fields of view, wherein the controller is operable to select a desired view of the image data for display on the display screen in response to a user's hand gesture as sensed by the at least one sensor.

### CROSS-REFERENCE TO RELATED APPLICATION

This application claims priority to and the benefit under 35 U.S.C. § 119(e) of U.S. Provisional Patent Application No. 63/652,248, filed on May 28, 2024, entitled “FULL DISPLAY REARVIEW ASSEMBLY VIDEO MANAGEMENT SYSTEM,” by Leah R. Hoffmeyer et al., the entire disclosure of which is incorporated herein by reference.

### TECHNICAL FIELD

The present disclosure generally relates to a display system for a vehicle and more particularly to a display system providing various views from the vehicle.

### SUMMARY

According to one aspect of the present disclosure, a display system for a vehicle is disclosed. The display system comprises a display device disposed in a passenger compartment of the vehicle, the display device comprising a screen; at least one sensor for sensing a user's hand gestures; and a controller in communication with the display device, the at least one sensor, and a plurality of imagers configured to capture image data in a plurality of different fields of view, wherein the controller is operable to select a desired view of the image data for display on the display screen in response to a user's hand gesture as sensed by the at least one sensor.

According to another aspect of the present disclosure, a display system is provided for a vehicle. The display system includes: a display device disposed in a passenger compartment of the vehicle, the display device having a display screen; a first sensor comprising a first array of proximity sensors for sensing a vertical component of a user's hand gesture; a second sensor comprising a first array of proximity sensors for sensing a horizontal component of a user's hand gesture; and a controller in communication with the display device, the at least one sensor, and a plurality of imagers configured to capture image data in a plurality of different fields of view, wherein the controller is operable to select a desired view of the image data for display on the display screen in response to a user's hand gesture as sensed by the first and second sensors.

According to another aspect of the present disclosure, a display system is provided for a vehicle. The display system includes: a display device disposed in a passenger compartment of the vehicle, the display device having a display screen; at least one sensor for sensing a user's hand gestures, the at least one sensor includes a rear passenger imager for capturing images in a field of view encompassing rear passengers; and a controller in communication with the display device, the at least one sensor, and a plurality of imagers configured to capture image data in a plurality of different fields of view, wherein the controller is operable to select images to display on the display screen from the images captured by the rear passenger imager in response to gestures by a rear passenger sensed using the images captured by the rear passenger imager.

These and other features, advantages, and objects of the present disclosure will be further understood and appreciated by those skilled in the art by reference to the following specification, claims, and appended drawings.

### BRIEF DESCRIPTION OF THE DRAWINGS

The present disclosure will become more fully understood from the detailed description and the accompanying drawings, wherein:

FIG. 1A is a top view of a vehicle comprising a display system;

FIG. 1B is another top view of the vehicle shown in FIG. 1A showing a portion of the interior of the vehicle;

FIG. 1C is a side view of the vehicle shown in FIG. 1A pulling a trailer;

FIG. 1D is a top view of the vehicle pulling a trailer;

FIG. 2 is an interior view of the vehicle shown in FIG. 1A;

FIG. 3A is a front view of a rearview display assembly of the vehicle shown in FIG. 1A;

FIG. 3B is a side cross-sectional view of the rearview display assembly shown in FIG. 3A;

FIG. 4A is an example of a full display mode shown on a display of the vehicle in FIG. 1A;

FIG. 4B is another example of a full display mode shown on a display of the vehicle in FIG. 1A having a zoomed-in field of view of the image shown in FIG. 4A;

FIG. 4C shows an example of a picture-in-picture display mode shown on a display of the vehicle in FIG. 1A;

FIG. 4D is another example of a picture-in-picture display mode shown on a display of the vehicle in FIG. 1A;

FIG. 5A is another example of a full display mode shown on a display of the vehicle in FIG. 1A;

FIG. 5B is another example of a picture-in-picture display mode shown on a display of the vehicle in FIG. 1A;

FIG. 5C is an example of a side-by-side display mode shown on a display of the vehicle in FIG. 1A; and

FIG. 6 is a block diagram of a display system implemented in the vehicle shown in FIG. 1A.

### DETAILED DESCRIPTION

The present illustrated embodiments reside primarily in combinations of method steps and apparatus components related to an image sensor system and method thereof. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Imagers have become commonplace within vehicles. A plurality of imagers may be provided in a vehicle. Such imagers may include a rearward imager, a trailer hitch view imager, a truck bed imager, a backup imager, a baby camera (for rearward facing car seats), rear occupant imagers, side (blind spot) imagers, forward imagers, etc. Because there generally is not sufficient space in a vehicle instrument panel to provide for a display to display each of the video feeds from all these imagers, the video feeds may be displayed on a single display one at a time based on driving conditions. For example, a display in a rearview display assembly may display the video feed from the rearview camera for general driving conditions and a video feed from a side imager may be superimposed on a portion of the display when another vehicle is detected in a corresponding blind spot. However, there is no user-friendly way to display other video feeds on that display assembly.

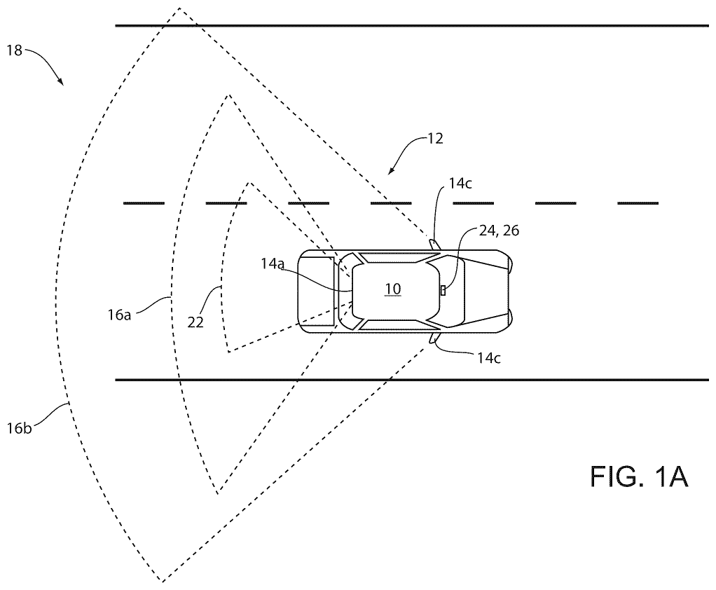

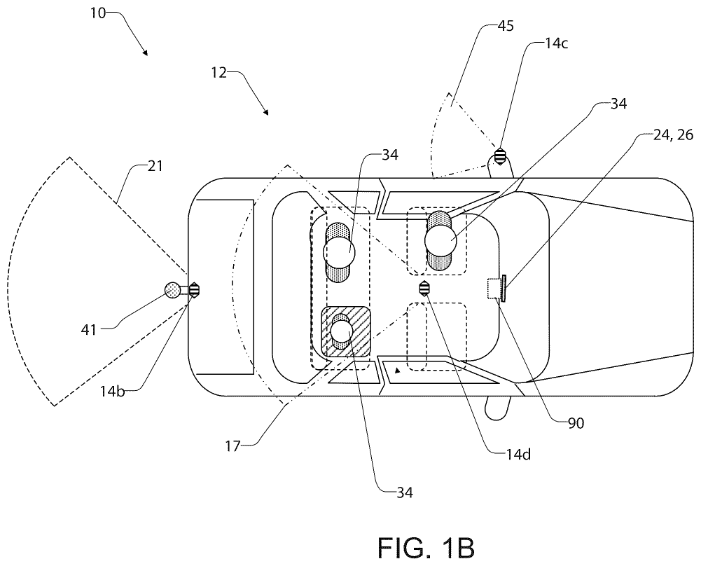

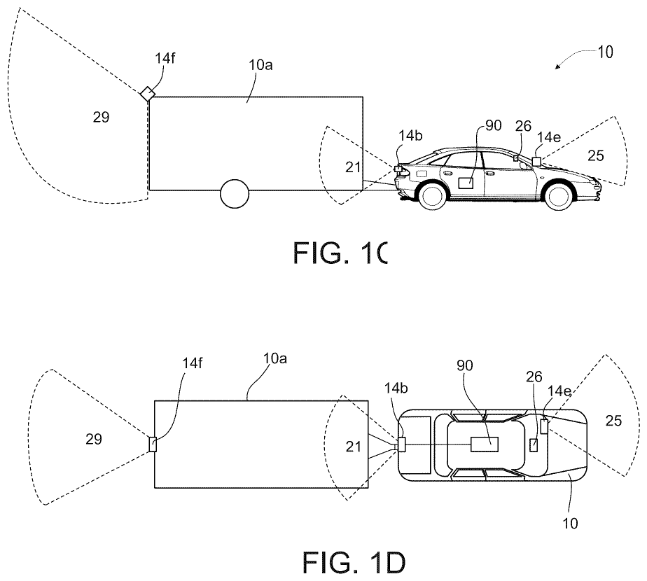

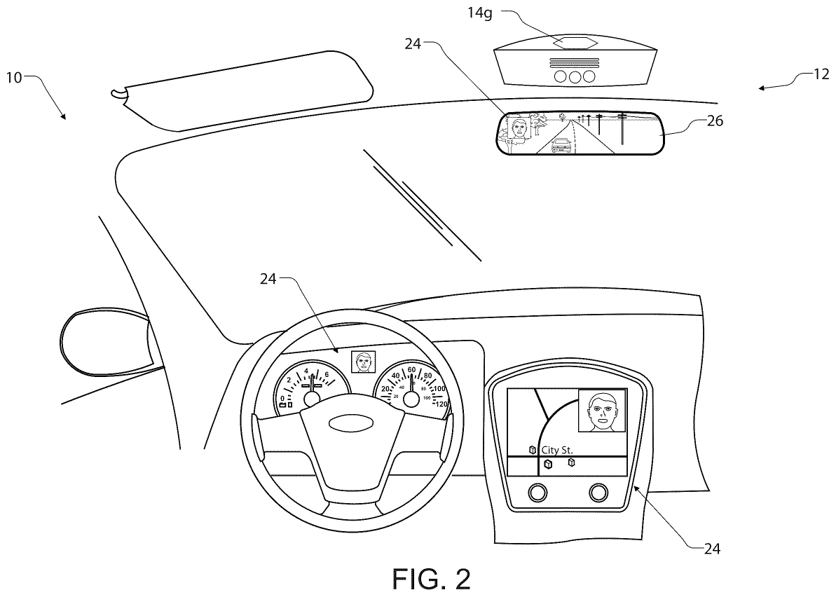

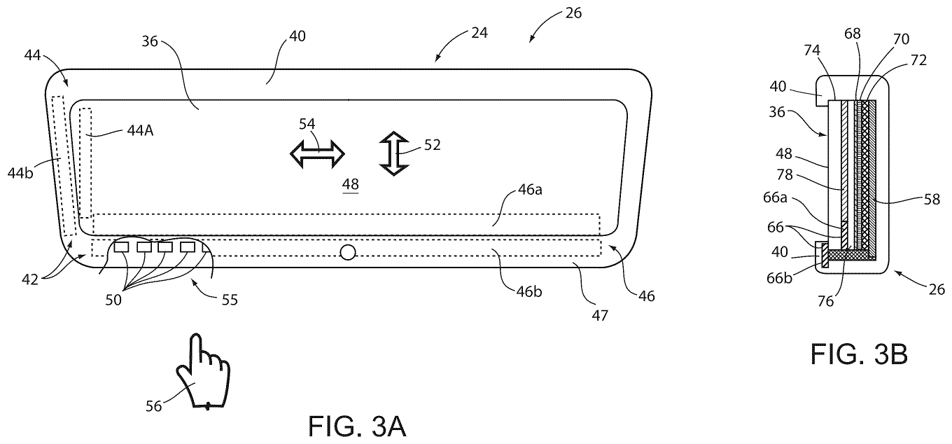

Referring to FIGS. 1A-1D, a vehicle 10 is shown equipped with a display system 12. The vehicle 10 comprises a plurality of imagers. As shown in FIG. 1A, the plurality of imagers may include a rearward imager 14a configured to capture a field of view 16a corresponding to a scene 18. The rearward imager 14a is configured to capture image data corresponding to the field of view 16a and display the image data on a display device 24. The display device 24 may be operable to adjust a desired view 22 of the image data as it is displayed on a display screen of the display device 24. Further detailed description of an exemplary embodiment of the display device 24 is discussed in reference to FIGS. 2, 3A, and 3B. The imagers may also include one or more side (blind spot) imagers 14c for capturing images in a field of view to the side of the vehicle 10. The video feeds from imagers 14a and 14c may be combined to form a larger field of view 16b.

As shown in FIG. 1B, the plurality of imagers may further include: a trailer hitch imager 14b for capturing images in a field of view 21 encompassing a trailer hitch 41; one or more side (blind spot) imagers 14c for capturing images in a field of view 45 to the side of the vehicle 10; and a rear passenger imager 14d for capturing images in a field of view 17 encompassing rear passengers 34.

As shown in FIGS. 1C and 1D, the plurality of imagers may further include a forward imager 14e for capturing images in a forward field of view 25. The display system 12 may also display images captured from imagers associated with a trailer 10a that is pulled by the vehicle 10. Such trailer imagers may include a trailer rearview imager 14f for capturing images in the field of view 29 and an interior trailer imager (not shown) for capturing images of the interior of the trailer 10a. The forward field of view 25, the rearward field of view 16a, and the side fields of view 45 may also be combined by a process known as stitching to provide a bird's eye field of view video feed showing a view from above the vehicle looking downward. Further, another field of view may be created by combining video feeds from two or more imagers using stitching so that they appear as one continuous field of view. For example, the rearward field of view 16a may be combined with one or both of the side fields of view 45 to provide a wider reward field of view than would otherwise be captured by any one of the imagers.

FIG. 2 shows the interior of the vehicle 10 as would be seen by the driver. The display system 12 may include one or more displays 24, one of which is located in a rearview display assembly 26.

Referring now to FIGS. 3A and 3B, a front view and a side cross-sectional view of the rearview display assembly 26 are shown, respectively. The rearview display assembly 26 may comprise a display device 24 having a display screen 36, which may be retained in the assembly 26 by a bezel 40. A user interface 42 may be disposed proximate the bezel 40, the display screen 36, or any location on the display assembly 26. For example, the user interface 42 may comprise a first sensor 44 and a second sensor 46. The first sensor 44 may include a first proximity sensor 44a and a second proximity sensor 44b. The second sensor 46 may include a third proximity sensor 44a and a fourth proximity sensor 44b. The first sensor 44 and the second sensor 46 may correspond to directional controls, which may be disposed behind the bezel 40 or behind a display surface 48 of the display assembly 26. In some embodiments, as best shown in FIG. 3B, the bezel 40 may extend around a perimeter of a front surface or the display surface 48 of the display assembly 26.

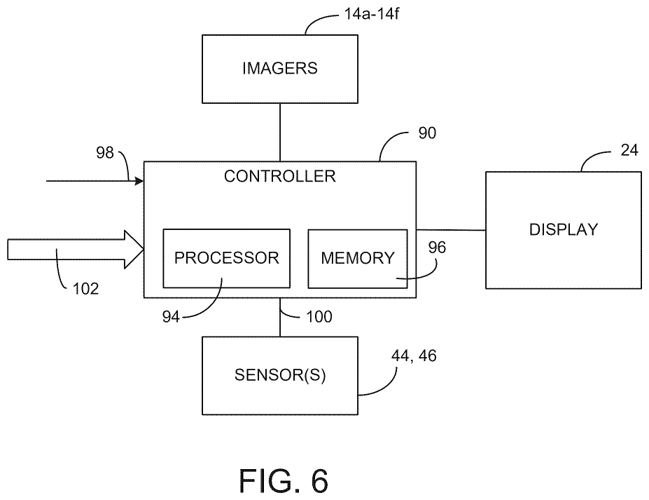

For example, the first proximity sensor 44a and the third proximity sensor 46a may be disposed behind the display surface 48. In some embodiments, the second proximity sensor 44b and the fourth proximity sensor 46b may be disposed behind an outer surface 47 of the bezel 40. In each of the configurations discussed herein, the first sensor 44 may correspond to an up/down input and the second sensor 46 may correspond to a left/right input. Each of the sensors may correspond to an array 50 of proximity sensors arranged along a portion of the display assembly 26. The proximity sensors may correspond to capacitive sensors in communication with a controller 90 (FIG. 6). However, it shall be appreciated by those skilled in the art that other types of proximity sensors can be used in addition to or in alternative to the capacitive sensors. Such sensors may include, but are not limited to, inductive sensors, optical sensors, resistive sensors, temperature sensors, the like, or any combination thereof.

The first proximity sensor 44a and the second proximity sensor 46a are shown positioned proximate a left side portion and a bottom portion of the display assembly 26, respectively. However, it shall be understood that the first proximity sensor 44a and the second proximity sensor 46a may be positioned proximate a right side portion and a top portion of the display assembly 26 as well as being located in any location behind the display surface 48. In some implementations, the display assembly 26 may correspond to a display that does not incorporate a bezel or a frameless display device. It shall further be understood that such embodiments may be implemented utilizing proximity sensors similar to the first proximity sensor 44a and the second proximity sensor 46a.

The array 50 of the proximity sensors may be arranged approximately in an up/down direction 52 and a left/right direction 54 relative the screen 36. The left/right direction 54 may correspond to approximately a direction from the driver side to the passenger side of the vehicle 10. Each of the directions 52 and 54 discussed herein may be adjusted relative to the display assembly 26, which may be mounted to a windshield of the vehicle 10 by an adjustable and/or pivotal mount. As such, the directions 52 and 54 are discussed herein in reference to the display assembly 26 arranged in a position aligned with the up/down and left/right directions of the vehicle 10 for clarity.

An exemplary embodiment of an array 50 of the proximity sensors is shown in reference to a cutout portion 55 of the bezel 40. In this example, the array 50 of the proximity sensors may correspond to a plurality of evenly spaced capacitive proximity sensors that are configured to output a proximity signal in the form of an electrical signal. The proximity signal may identify a proximity of an object 56, for example a digit of a user, proximate one or more of the individual sensors of the array 50. In this way, the controller 90 may identify the motion of one or more objects in relation to the proximity sensors of the array 50 to identify a motion or a gesture of one or more objects.

The array 50 of proximity sensors may provide for various input controls in response to the object 56 being detected proximate the display assembly 26. Accordingly, one or more inputs or gestures proximate the front surface (e.g. the display surface 48) and/or in proximity to the bezel 40, the perimeter, sides of the display device, etc. may be communicated to the controller 90. In response to the one or more gestures and/or inputs, the controller 90 may be configured to control various features of the display assembly 26. For example, the controller 90 may provide for controls to select a display mode, select video feeds to display, scale, crop, and/or pan the image data in the field of view 16 in response to an input. Additionally, the detection of the one or more gestures and/or inputs may be utilized by the controller 90 to control one or more menus, display modes, and functions of the display assembly 26.

Referring now to FIG. 3B, a cross-sectional view of an exemplary embodiment of the display assembly 26 is shown. The controller 90 may be disposed in the display assembly 26. The controller 90 may be mounted to or in communication with a printed circuit board (PCB) 58. The controller 90 may be configured to control the display screen 36, which may correspond to any form of display, for example a light emitting diode (LED) display, liquid crystal display (LCD), organic LED (OLED), etc. In the example utilizing the LCD display, the controller 90 may be in communication with at least one sensing electrode 66, a transparent electrode 68, an LCD display 70, and a backlight 72.

The at least one sensing electrode 66 is shown disposed behind a first transparent substrate 74 and the bezel 40. In this configuration, the at least one sensing electrode 66 may be utilized in combination with the transparent electrode 68 to function as capacitive sensors corresponding to the second sensor 46. The sensing electrode 66 may be separated from the transparent electrode 68 by a second transparent substrate 76 in connection via an adhesive 78. The display assembly 26 may incorporate one or more of the sensing electrodes 66, which may correspond to the third and fourth proximity sensors 46a and 46b as illustrated in FIG. 3B. The first and second transparent substrates 74 and 76 may be of glass or another substantially light transmissive material. The sensing electrode 66 and the transparent electrode 68 may be formed of a transparent conductive material (e.g., indium tin oxide (ITO)), and a film formed by patterning the transparent conductive material on the second transparent substrate 76 to implement the proximity sensors 44 and 46 discussed herein.

As shown in FIG. 3B, a first sensing electrode 66a may correspond to the third proximity sensor 46a and the second sensing electrode 66b may correspond to the fourth proximity sensor 46b. As discussed previously, the proximity sensors 44a, 44b, 46a, and 46b may be incorporated in the display device 12 alone or in any combination. The outer surface of the first transparent substrate 74 may correspond to the display surface 48. Adjacent to the second transparent substrate 76, the LCD display 70 and the backlight 72, which correspond to the display device 24, may be disposed and may further be mounted to the PCB 58. In this configuration, the display assembly 26 may be operable to display the image data captured by the imagers on the display screen 36 and detect the object 56 to control a position and/or scale of the image data within the selected field of view.

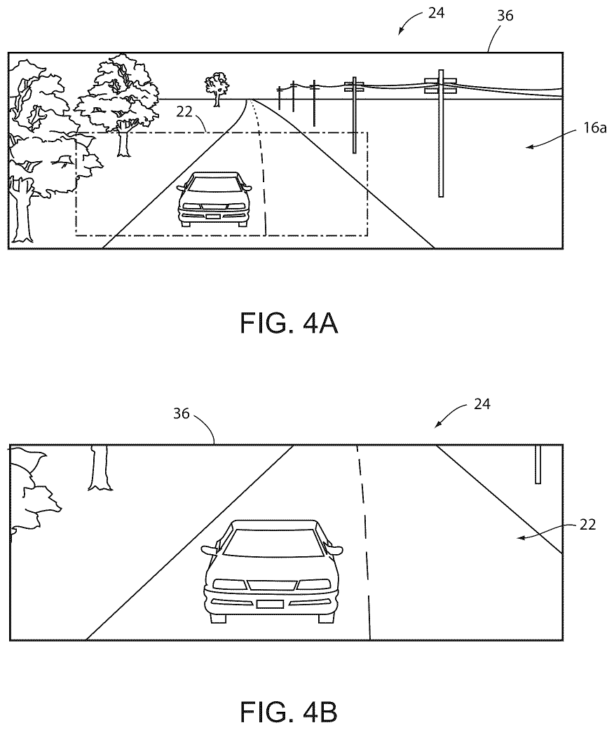

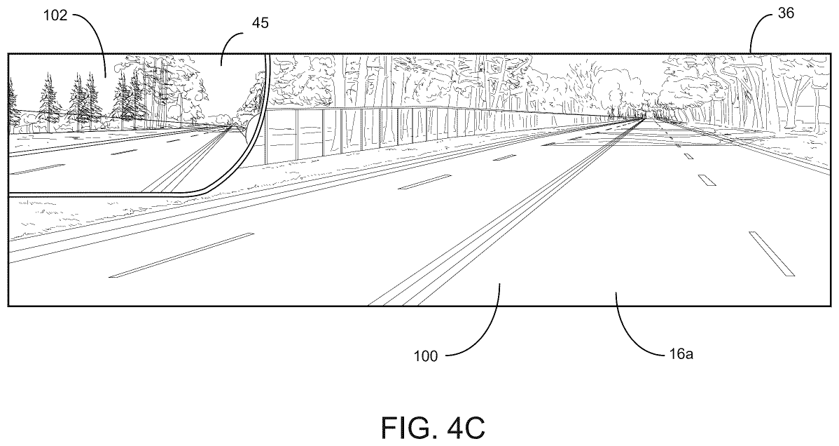

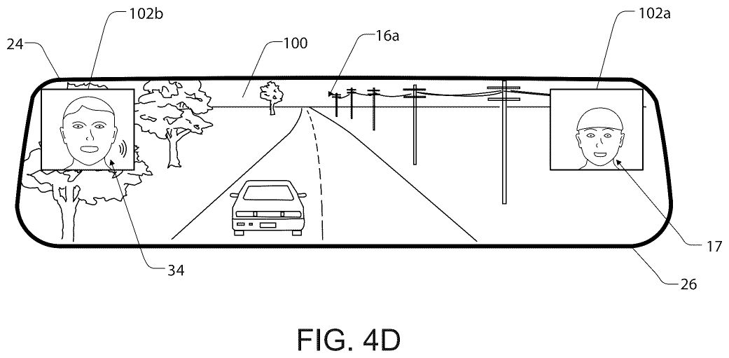

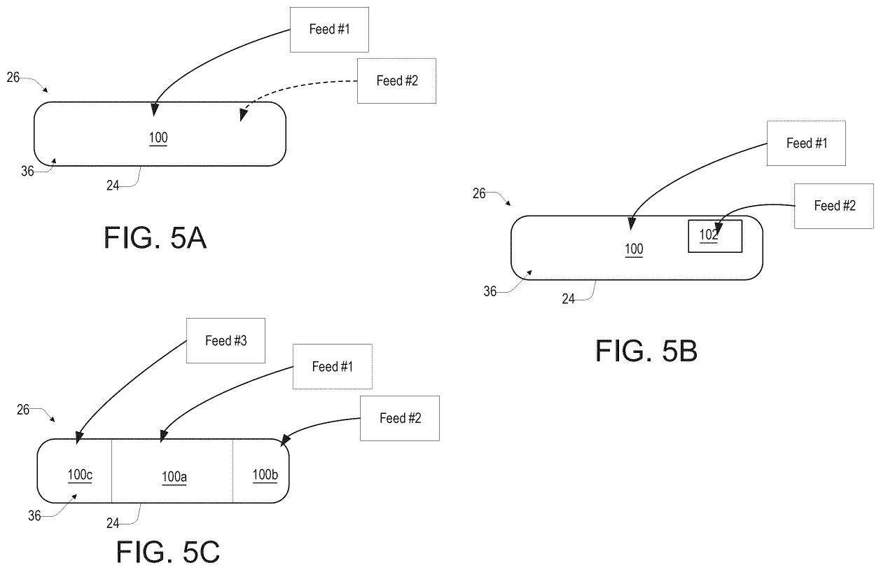

In operation, a user may slide one or more digits, demonstrated as the object 56, along at least one of the sensors 44 and/or 46. An up or down motion along the first sensor 44 may result in the controller 90 selecting a full display mode (FIGS. 4A, 4B, 5A), a picture-in-picture mode (FIGS. 4C, 4D, 5B) and a side-by-side mode (FIG. 5C). In the full display mode (FIG. 5A), the display screen 36 would show only one video feed from one imager or from a combined (stitched) video feed from multiple imagers across the entire display area 100, whereas in a picture-in-picture mode (FIG. 5B), a second video feed is superimposed on a portion 102 of the otherwise full display video feed across area 100. In a side-by-side mode (FIG. 5C) three video feeds may be displayed in adjacent areas 100a, 100b, 100c. Other display modes may be possible. A left or right motion along the second sensor 46 may result in the controller 90 selecting one or more video feeds to display depending on the display mode selected. This allows a user to easily switch between video feeds in a user-friendly manner. Additionally, moving two digits or objects from positions close in proximity to each other to positions further away along one of the proximity sensors 44 or 46, or vice versa, may increase or decrease the scale of the image data to be displayed in the desired view 22. An example of the change in scale is shown in FIGS. 4A and 4B. In FIG. 4A, the full field of view 16a is shown on the display screen 36 with an area identified as the desired field of view 22. In FIG. 4B, the desired field of view 22 is shown on the display screen 36 as a result of a gesture indicating to scale the displayed field of view.

In FIG. 4C, a picture-in-picture mode is used to display a first video feed of the field of view 16a from the imager 14a across an area 100, and a second video feed of the field of view 45 from the imager 14c presented in a smaller area 102 superimposed on area 100. In FIG. 4D, a first video feed of the field of view 16a from the imager 14a is displayed across an area 100, and a second video feed of the field of view 17 from the imager 14d is presented in a smaller area 102a superimposed on area 100. Also, a third video feed of the field of view from the imager 14g is presented in a second smaller area 102b superimposed on area 100.

Referring back to FIG. 2, it may be possible to use a driver monitor imager 14g that captures images of the driver in order to detect user gestures instead of, or in addition to, the proximity sensors used in the embodiment shown in FIGS. 3A and 3B. The driver monitor imager 14g may be placed in an overhead console or in the rearview display assembly 26.

Referring now to FIG. 6, a block diagram of the display system 12 is shown. The plurality of imagers 14a-14f are shown in communication with the controller 90. The controller 90 may comprise a processor 94 operable to process the image data as supplied in analog or digital form from the imagers 14a-14f. In various embodiments, the processor 94 may be implemented as a plurality of processors, a multicore processor, or any combination of processors, circuits, and peripheral processing devices.

The controller 90 may further comprise a memory 96. The memory 96 may comprise various forms of memory, for example, random access memory (RAM), dynamic RAM (DRAM), synchronous DRAM (SDRAM), and other forms of memory configured to store digital information. The memory 96 may be configured to store the image data for processing. Processing the image data may comprise selecting, scaling, combining (stitching), and cropping the image data to adjust a position and apparent size of the image data as it is output to the display screen 36 of the display assembly 26. In some embodiments the memory 96 may further be configured to store a plurality of user profiles, each corresponding to a specific desired view that may be recalled in relation to a particular operator of the vehicle 10.

The controller 90 may be further configured to also change the display mode in response to vehicle operating parameters. The vehicle operating parameters include vehicle speed, vehicle gear, turn signal activation, and proximity to an external object, such as an obstacle, an animal, a pedestrian, a cyclist, or a nearby vehicle. Specifically, the controller 90 may further be in communication with a plurality of inputs for example, a speed input 98, a proximity sensor input 100, and a vehicle bus 102. The speed input 98 may provide a signal communicating a speed of the vehicle 10 via a speedometer or any device operable to measure and communicate data corresponding to the speed of a vehicle 10. The proximity sensor input 100 may be configured to receive signals from one or more of the proximity sensors 44 and 46 to select the desired video feed(s) and display mode and/or adjust the desired view 22 of the image data within the field of view 16a. The vehicle bus 102 may be implemented using any suitable standard communication bus, such as a Controller Area Network (CAN) bus, a Local Interconnect Network (LIN) bus, etc. The vehicle bus 102 may be configured to provide a variety of additional information to the controller 90. Such information may correspond to one or more vehicle states, for example a gear selection, passenger occupancy, a headlight activation, etc.

The detection of gestures may also be used to control the vehicle's sunroof. In addition, the gestures detected may be hand motions or may be stationary gestures such as a peace sign or holding up various fingers in different orientations.

Further, when an interior image sensor is used to sense gestures, the system may be configured to detect gestures by passengers other than the driver. For example, a rear passenger could make a gesture that the image sensor recognizes and responds by causing an image of the rear passenger to appear on a portion of the display for purposes of carrying out a conversation.

It will be appreciated that embodiments of the disclosure described herein may be comprised of one or more conventional processors and unique stored program instructions that control one or more processors to implement, in conjunction with certain non-processor circuits, some, most, or all of the functions of an image sensor system and method thereof, as described herein. The non-processor circuits may include, but are not limited to signal drivers, clock circuits, power source circuits, and/or user input devices. Alternatively, some or all functions could be implemented by a state machine that has no stored program instructions, or in one or more application specific integrated circuits (ASICs), in which each function or some combinations of the functions are implemented as custom logic. Of course, a combination of the two approaches could be used. Thus, the methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It should be appreciated by those skilled in the art that the above described components may be combined in additional or alternative ways not explicitly described herein. Modifications of the various implementations of the disclosure will occur to those skilled in the art and to those who apply the teachings of the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

What is claimed is:

1. A display system for a vehicle, the display system comprising:
a display device disposed in a passenger compartment of the vehicle, the display device comprising a display screen;
at least one sensor for sensing a user's hand gestures; and
a controller in communication with the display device, the at least one sensor, and a plurality of imagers configured to capture image data in a plurality of different fields of view, wherein the controller is operable to select a desired view of the image data for display on the display screen in response to a user's hand gesture as sensed by the at least one sensor.

2. The display system according to claim 1, wherein the display device is disposed in a rearview display assembly.

3. The display system according to claim 1, wherein the at least one sensor includes a plurality of proximity sensors.

4. The display system according to claim 1, wherein the at least one sensor includes an imager.

5. The display system according to claim 1, wherein the controller is operable to select a desired display mode in which to display image data on the display screen in response to a user's hand gesture received by the at least one sensor.

6. The display system according to claim 5, wherein the controller is operable to select the desired display mode from a full display mode, a superimposed display mode, and a side-by-side display mode.

7. The display system according to claim 1, wherein the controller is further operable to process the image data by scaling, combining, and/or cropping in response to a user's hand gesture received by the at least one sensor.

8. The display system according to claim 1, wherein the controller is further configured to change the display mode in response to vehicle operating parameters.

9. The display system according to claim 8, wherein the vehicle operating parameters include vehicle speed, vehicle gear, turn signal activation, and proximity to an external object.

10. The display system according to claim 1, wherein the controller is further configured to control a sunroof of the vehicle in response to a user's hand gesture received by the at least one sensor.

11. The display system according to claim 1, wherein the controller is further configured to select which of a plurality of available fields of view to display in response to a user's hand gesture received by the at least one sensor.

12. The display system according to claim 1, wherein the at least one sensor includes a rear passenger imager for capturing images in a field of view encompassing rear passengers, and wherein the controller is operable to select images to display on the display screen from the images captured by the rear passenger imager in response to gestures by a rear passenger sensed using the images captured by the rear passenger imager.

13. The display system according to claim 1, wherein the at least one sensor comprises a first sensor for sensing a vertical component of a user's hand gesture and a second sensor for sensing a horizontal component of a user's hand gesture.

14. The display system according to claim 13, wherein each of the first and second sensors comprise an array of proximity sensors.

15. A display system for a vehicle, the display system comprising:
a display device disposed in a passenger compartment of the vehicle, the display device comprising a display screen;
a first sensor comprising a first array of proximity sensors for sensing a vertical component of a user's hand gesture;
a second sensor comprising a first array of proximity sensors for sensing a horizontal component of a user's hand gesture; and
a controller in communication with the display device, the at least one sensor, and a plurality of imagers configured to capture image data in a plurality of different fields of view, wherein the controller is operable to select a desired view of the image data for display on the display screen in response to a user's hand gesture as sensed by the first and second sensors.

16. The display system according to claim 15, wherein the controller is operable to select a desired display mode in which to display image data on the display screen in response to a user's hand gesture as sensed by the first and second sensors.

17. The display system according to claim 15, wherein the controller is further configured to change the display mode in response to vehicle operating parameters.

18. The display system according to claim 15, wherein the controller is further configured to select which of a plurality of available fields of view to display in response to a user's hand gesture as sensed by the first and second sensors.

19. A display system for a vehicle, the display system comprising:
a display device disposed in a passenger compartment of the vehicle, the display device comprising a display screen;
at least one sensor for sensing a user's hand gestures, the at least one sensor includes a rear passenger imager for capturing images in a field of view encompassing rear passengers; and
a controller in communication with the display device, the at least one sensor, and a plurality of imagers configured to capture image data in a plurality of different fields of view, wherein the controller is operable to select images to display on the display screen from the images captured by the rear passenger imager in response to gestures by a rear passenger sensed using the images captured by the rear passenger imager.

20. The display system of claim 19, wherein the at least one sensor further includes a sensor for sensing a driver's hand gestures, and wherein the controller is operable to select a desired view of the image data for display on the display screen in response to a driver's hand gesture.
